(19) United States
(12) Patent Application Publication
(10) Pub. No.: US 2021/0248707 A1
(43) Pub. Date: Aug. 12, 2021

(54) PERSONALIZED EXPERIENCE WAGERING ON LIVE EVENT

(71) Applicant: AdrenalineIP, Washington, DC (US)

(72) Inventors: Casey Alexander HUKE, Washington, DC (US); John CRONIN, Jericho, VT (US); Michael BAKER, Georgie, VT (US); Joseph BODKIN, Quincy, MA (US)

(73) Assignee: AdrenalineIP, Washington, DC (US)

(21) Appl. No.: 17/085,093

(22) Filed: Oct. 30, 2020

Related U.S. Application Data
(60) Provisional application No. 62/970,844, filed on Feb. 6, 2020.

(51) Int. Cl. G06Q 50/34; G07F 17/32

(52) U.S. Cl. CPC G06Q 50/34; G07F 17/323; G07F 17/3288; G07F 17/3244; G07F 17/3237

(57) ABSTRACT

A method for providing personalized bets to a user betting on plays during a live event by determining the user's level of knowledge about the live event via a series of questions or prompts on the user device, selecting one or more bets relevant to the live event from an eligible bet database matching the knowledge level of the user and determining the baseline odds of the bets based on historical data from a play history database. Further, collecting interactions by the user with the user device, storing the user interactions in the user interaction database and polling the user interaction database to determine a baseline level of engagement based on past live events and determining a relative level of engagement of the user with the user device at the current live event.

### FIELD

The embodiments generally relate to gambling, particularly live events such as sporting events.

### BACKGROUND

A bettor may restrict their betting to a particular type of bet or another criterion such as odds meeting their own personal threshold. Behaviors such as this restrict the potential number of bets which may be made.

Some bettors may be more likely to take a particular type of bet regardless of the odds. In this case, offering the bettor the same odds as someone less likely to make the bet would be contrary to the interests of the bookmaker, as they would likely make the bet even with poorer odds.

Environmental factors such as home team advantage, and the likelihood of a bettor favoring the home team. As such, the bettor may be more likely to favor bets pertaining to the home team. Similar to favoring a particular kind of bet, the favoring of one team versus another may result in the bettor making fewer bets.

A bookmaker collects a fee on every bet placed, therefore it is beneficial to the bookmaker to increase the number of bets made. By incentivizing bets which would otherwise not be made by increasing the odds in favor of the bettor, the bookmaker can increase the overall number of bets made. Similarly, there is a benefit to reducing the payout wherever possible, therefore it is beneficial to identify bets which have a high likelihood of receiving a bet by a bettor, even a lower odd that would otherwise be offered, and decreasing the odds for the bet before offering the bet to the bettor.

### SUMMARY

A method of offering and displaying wagers to a user of a betting or wagering game. The method can include selecting at least one bet to present to a bettor in a betting game, calculating baseline odds for the bet, adjusting the baseline odds for the bet based on user specific data, and presenting the bet with odds adjusted based on the user specific data to the user.

In another exemplary embodiment, a method of offering bets on a play in at a live event may include compiling a plurality of bets available to be offered in a betting game; calculating baseline odds for each of the plurality of bets; determining a knowledge level of a user of the betting game; and adjusting at least one of the availability of bets among the plurality of bets and the odds of bets among the plurality of bets based on the knowledge level of the user.

In another embodiment, a computer implemented method for providing bets on a play at a live event, executed by a processor, can include displaying a betting game interface; displaying one or more live events, the one or more live events capable of having wagers placed thereon; displaying one or more questions or prompts for information; and displaying one or more bets available to be made as a result to data collected and analyzed in response to the one or more questions or prompts for information.

### BRIEF DESCRIPTIONS OF THE DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates a personalized wagering on live events, according to an embodiment.

FIG. 2 illustrates an eligible bet database, according to an embodiment.

FIG. 3 illustrates a historic play database, according to an embodiment.

FIG. 4 illustrates an odds calculation module, according to an embodiment.

FIG. 5: illustrates a base module, according to an embodiment.

FIG. 6: illustrates a wager history database, according to an embodiment.

FIG. 7: illustrates a user interaction module, according to an embodiment.

FIG. 8: illustrates a user interaction database, according to an embodiment.

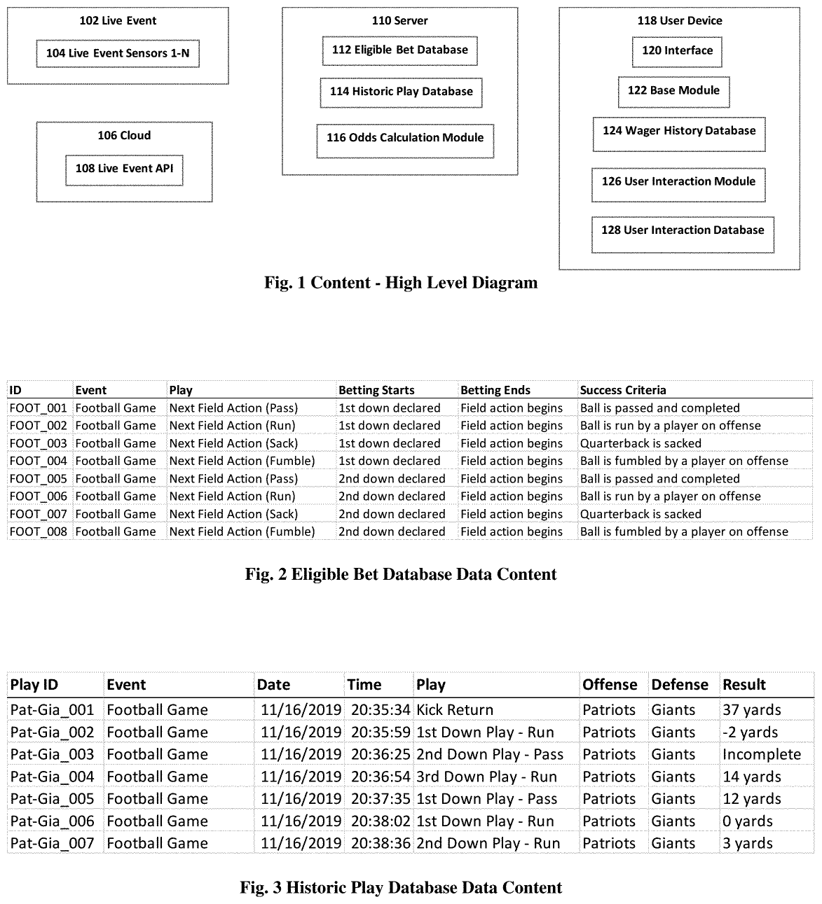

### DETAILED DESCRIPTION

Aspects of the present invention are disclosed in the following description and related figures directed to specific embodiments of the invention. Those of ordinary skill in the art will recognize that alternate embodiments may be devised without departing from the spirit or the scope of the claims. Additionally, well-known elements of exemplary embodiments of the invention will not be described in detail or will be omitted so as not to obscure the relevant details of the invention

As used herein, the word exemplary means serving as an example, instance or illustration. The embodiments described herein are not limiting, but rather are exemplary only. It should be understood that the described embodiments are not necessarily to be construed as preferred or advantageous over other embodiments. Moreover, the terms embodiments of the invention, embodiments or invention do not require that all embodiments of the invention include the discussed feature, advantage, or mode of operation.

Further, many of the embodiments described herein are described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, a computer configured to perform the described action.

With respect to the embodiments, a summary of terminology used herein is provided.

An action refers to a specific play or specific movement in a sporting event. For example, an action may determine which players were involved during a sporting event. In some embodiments, an action may be a throw, shot, pass, swing, kick, hit, performed by a participant in a sporting event. In some embodiments, an action may be a strategic decision made by a participant in the sporting event such as a player, coach, management, etc. In some embodiments, an action may be a penalty, foul, or type of infraction occurring in a sporting event. In some embodiments, an action may include the participants of the sporting event. In some embodiments, an action may include beginning events of sporting event, for example opening tips, coin flips, opening pitch, national anthem singers, etc. In some embodiments, a sporting event may be football, hockey, basketball, baseball, golf, tennis, soccer, cricket, rugby, MMA, boxing, swimming, skiing, snowboarding, horse racing, car racing, boat racing, cycling, wrestling, Olympic sport, eSports, etc. Actions can be integrated into the embodiments in a variety of manners.

A “bet” or “wager” is to risk something, usually a sum of money, against someone else's or an entity on the basis of the outcome of a future event, such as the results of a game or event. It may be understood that non-monetary items may be the subject of a “bet” or “wager” as well, such as points or anything else that can be quantified for a “wager” or “bet.” A bettor refers to a person who bets or wagers. A bettor may also be referred to as a user, client, or participant throughout the present invention. A “bet” or “wager” could be made for obtaining or risking a coupon or some enhancements to the sporting event, such as better seats, VIP treatment, etc. A “bet” or “wager” can be done for certain amount or for a future time. A “bet” or “wager” can be done for being able to answer a question correctly. A “bet” or “wager” can be done within a certain period of time. A “bet” or “wager” can be integrated into the embodiments in a variety of manners.

A “book” or “sportsbook” refers to a physical establishment that accepts bets on the outcome of sporting events. A “book” or “sportsbook” system enables a human working with a computer to interact, according to set of both implicit and explicit rules, in an electronically powered domain for the purpose of placing bets on the outcome of sporting event. An added game refers to an event not part of the typical menu of wagering offerings, often posted as an accommodation to patrons. A “book” or “sportsbook” can be integrated into the embodiments in a variety of manners.

To “buy points” means a player pays an additional price (more money) to receive a half-point or more in the player's favor on a point spread game. Buying points means you can move a point spread, for example up to two points in your favor. “Buy points” can be integrated into the embodiments in a variety of manners.

The “price” refers to the odds or point spread of an event. To “take the price” means betting the underdog and receiving its advantage in the point spread. “Price” can be integrated into the embodiments in a variety of manners.

“No action” means a wager in which no money is lost or won, and the original bet amount is refunded. “No action” can be integrated into the embodiments in a variety of manners.

The “sides” are the two teams or individuals participating in an event: the underdog and the favorite. The term “favorite” refers to the team considered most likely to win an event or game.

The “chalk” refers to a favorite, usually a heavy favorite. Bettors who like to bet big favorites are referred to “chalk eaters” (often a derogatory term). An event or game in which the sports book has reduced its betting limits, usually because of weather or the uncertain status of injured players is referred to as a “circled game.” “Laying the points or price” means betting the favorite by giving up points. The term “dog” or “underdog” refers to the team perceived to be most likely to lose an event or game. A “longshot” also refers to a team perceived to be unlikely to win an event or game. “Sides”, “favorite”, “chalk”, “circled game”, “laying the points price”, “dog” and “underdog” can be integrated into the embodiments in a variety of manners.

The “money line” refers to the odds expressed in terms of money. With money odds, whenever there is a minus (−) the player “lays” or is “laying” that amount to win (for example $100); where there is a plus (+) the player wins that amount for every $100 wagered. A “straight bet” refers to an individual wager on a game or event that will be determined by a point spread or money line. The term “straight-up” means winning the game without any regard to the “point spread”; a “money-line” bet. “Money line”, “straight bet”, “straight-up” can be integrated into the embodiments in a variety of manners.

The “line” refers to the current odds or point spread on a particular event or game. The “point spread” refers to the margin of points in which the favored team must win an event by to “cover the spread.” To “cover” means winning by more than the “point spread”. A handicap of the “point spread” value is given to the favorite team so bettors can choose sides at equal odds. “Cover the spread” means that a favorite win an event with the handicap considered or the underdog wins with additional points. To “push” refers to when the event or game ends with no winner or loser for wagering purposes, a tie for wagering purposes. A “tie” is a wager in which no money is lost or won because the teams' scores were equal to the number of points in the given “point spread”. The “opening line” means the earliest line posted for a particular sporting event or game. The term “pick” or “pick 'em” refers to a game when neither team is favored in an event or game. “Line”, “cover the spread”, “cover”, “tie”, “pick” and “pick-em” can be integrated into the embodiments in a variety of manners.

To “middle” means to win both sides of a game; wagering on the “underdog” at one point spread and the favorite at a different point spread and winning both sides. For example, if the player bets the underdog +4½ and the favorite −3½ and the favorite wins by 4, the player has middled the book and won both bets. “Middle” can be integrated into the embodiments in a variety of manners.

Digital gaming refers to any type of electronic environment that can be controlled or manipulated by a human user for entertainment purposes. A system that enables a human and a computer to interact according to set of both implicit and explicit rules, in an electronically powered domain for the purpose of recreation or instruction. “eSports” refers to a form of sports competition using video games, or a multiplayer video game played competitively for spectators, typically by professional gamers. Digital gaming and “eSports” can be integrated into the embodiments in a variety of manners.

The term event refers to a form of play, sport, contest, or game, especially one played according to rules and decided by skill, strength, or luck. In some embodiments, an event may be football, hockey, basketball, baseball, golf, tennis, soccer, cricket, rugby, MMA, boxing, swimming, skiing, snowboarding, horse racing, car racing, boat racing, cycling, wrestling, Olympic sport, etc. Event can be integrated into the embodiments in a variety of manners.

The “total” is the combined number of runs, points or goals scored by both teams during the game, including overtime. The “over” refers to a sports bet in which the player wagers that the combined point total of two teams will be more than a specified total. The “under” refers to bets that the total points scored by two teams will be less than a certain figure. “Total”, “over”, and “under” can be integrated into the embodiments in a variety of manners.

A “parlay” is a single bet that links together two or more wagers; to win the bet, the player must win all the wagers in the “parlay”. If the player loses one wager, the player loses the entire bet. However, if he wins all the wagers in the “parlay”, the player wins a higher payoff than if the player had placed the bets separately. A “round robin” is a series of parlays. A “teaser” is a type of parlay in which the point spread, or total of each individual play is adjusted. The price of moving the point spread (teasing) is lower payoff odds on winning wagers. “Parlay”, “round robin”, “teaser” can be integrated into the embodiments in a variety of manners.

A “prop bet” or “proposition bet” means a bet that focuses on the outcome of events within a given game. Props are often offered on marquee games of great interest. These include Sunday and Monday night pro football games, various high-profile college football games, major college bowl games and playoff and championship games. An example of a prop bet is “Which team will score the first touchdown?” “Prop bet” or “proposition bet” can be integrated into the embodiments in a variety of manners.

A “first-half bet” refers to a bet placed on the score in the first half of the event only and only considers the first half of the game or event. The process in which you go about placing this bet is the same process that you would use to place a full game bet, but as previously mentioned, only the first half is important to a first-half bet type of wager. A “half-time bet” refers to a bet placed on scoring in the second half of a game or event only. “First-half-bet” and “half-time-bet” can be integrated into the embodiments in a variety of manners.

A “futures bet” or “future” refers to the odds that are posted well in advance on the winner of major events, typical future bets are the Pro Football Championship, Collegiate Football Championship, the Pro Basketball Championship, the Collegiate Basketball Championship, and the Pro Baseball Championship. “Futures bet” or “future” can be integrated into the embodiments in a variety of manners.

The “listed pitchers” is specific to a baseball bet placed only if both of the pitchers scheduled to start a game actually start. If they don't, the bet is deemed “no action” and refunded. The “run line” in baseball, refers to a spread used instead of the money line. “Listed pitchers” and “no action” and “run line” can be integrated into the embodiments in a variety of manners.

The term “handle” refers to the total amount of bets taken. The term “hold” refers to the percentage the house wins. The term “juice” refers to the bookmaker's commission, most commonly the 11 to 10 bettors lay on straight point spread wagers: also known as “vigorish” or “vig”. The “limit” refers to the maximum amount accepted by the house before the odds and/or point spread are changed. “Off the board” refers to a game in which no bets are being accepted. “Handle”, “juice”, vigorish”, “vig” and “off the board” can be integrated into the embodiments in a variety of manners.

“Casinos” are a public room or building where gambling games are played. “Racino” is a building complex or grounds having a racetrack and gambling facilities for playing slot machines, blackjack, roulette, etc. “Casino” and “Racino” can be integrated into the embodiments in a variety of manners.

Customers are companies, organizations or individual that would deploy, for fees, and may be part of, of perform, various system elements or method steps in the embodiments.

Managed service user interface service is a service that can help customers (1) manage third parties, (2) develop the web, (3) do data analytics, (4) connect thru application program interfaces and (4) track and report on player behaviors. A managed service user interface can be integrated into the embodiments in a variety of manners.

Managed service risk management services are a service that assists customers with (1) very important person management, (2) business intelligence, and (3) reporting. These managed service risk management services can be integrated into the embodiments in a variety of manners.

Managed service compliance service is a service that helps customers manage (1) integrity monitoring, (2) play safety, (3) responsible gambling and (4) customer service assistance. These managed service compliance services can be integrated into the embodiments in a variety of manners.

Managed service pricing and trading service is a service that helps customers with (1) official data feeds, (2) data visualization and (3) land based, on property digital signage. These managed service pricing and trading services can be integrated into the embodiments in a variety of manners.

Managed service and technology platform are services that helps customers with (1) web hosting, (2) IT support and (3) player account platform support. These managed service and technology platform services can be integrated into the embodiments in a variety of manners.

Managed service and marketing support services are services that help customers (1) acquire and retain clients and users, (2) provide for bonusing options and (3) develop press release content generation. These managed service and marketing support services can be integrated into the embodiments in a variety of manners.

Payment processing services are those services that help customers that allow for (1) account auditing and (2) withdrawal processing to meet standards for speed and accuracy. Further, these services can provide for integration of global and local payment methods. These payment processing services can be integrated into the embodiments in a variety of manners.

Engaging promotions allow customers to treat your players to free bets, odds boosts, enhanced access and flexible cashback to boost lifetime value. Engaging promotions can be integrated into the embodiments in a variety of manners.

“Cash out” or “pay out” or “payout” allow customers to make available, on singles bets or accumulated bets with a partial cash out where each operator can control payouts by managing commission and availability at all times. The “cash out” or “pay out” or “payout” can be integrated into the embodiments in a variety of manners, including both monetary and non-monetary payouts, such as points, prizes, promotional or discount codes, and the like.

“Customized betting” allow customers to have tailored personalized betting experiences with sophisticated tracking and analysis of players' behavior. “Customized betting” can be integrated into the embodiments in a variety of manners.

Kiosks are devices that offer interactions with customers clients and users with a wide range of modular solutions for both retail and online sports gaming. Kiosks can be integrated into the embodiments in a variety of manners.

Business Applications are an integrated suite of tools for customers to manage the everyday activities that drive sales, profit, and growth, from creating and delivering actionable insights on performance to help customers to manage the sports gaming. Business Applications can be integrated into the embodiments in a variety of manners.

State based integration allows for a given sports gambling game to be modified by states in the United States or countries, based upon the state the player is in, based upon mobile phone or other geolocation identification means. State based integration can be integrated into the embodiments in a variety of manners.

Game Configurator allow for configuration of customer operators to have the opportunity to apply various chosen or newly created business rules on the game as well as to parametrize risk management. Game configurator can be integrated into the embodiments in a variety of manners.

“Fantasy sports connector” are software connectors between method steps or system elements in the embodiments that can integrate fantasy sports. Fantasy sports allow a competition in which participants select imaginary teams from among the players in a league and score points according to the actual performance of their players. For example, if a player in a fantasy sports is playing at a given real time sports, odds could be changed in the real time sports for that player.

Software as a service (or SaaS) is a method of software delivery and licensing in which software is accessed online via a subscription, rather than bought and installed on individual computers. Software as a service can be integrated into the embodiments in a variety of manners.

Synchronization of screens means synchronizing bets and results between devices, such as TV and mobile, PC and wearables. Synchronization of screens can be integrated into the embodiments in a variety of manners.

Automatic content recognition (ACR) is an identification technology to recognize content played on a media device or present in a media file. Devices containing ACR support enable users to quickly obtain additional information about the content they see without any user-based input or search efforts. To start the recognition, a short media clip (audio, video, or both) is selected. This clip could be selected from within a media file or recorded by a device. Through algorithms such as fingerprinting, information from the actual perceptual content is taken and compared to a database of reference fingerprints, each reference fingerprint corresponding to a known recorded work. A database may contain metadata about the work and associated information, including complementary media. If the fingerprint of the media clip is matched, the identification software returns the corresponding metadata to the client application. For example, during an in-play sports game a “fumble” could be recognized and at the time stamp of the event, metadata such as “fumble” could be displayed. Automatic content recognition (ACR) can be integrated into the embodiments in a variety of manners.

Joining social media means connecting an in-play sports game bet or result to a social media connection, such as a FACEBOOK® chat interaction. Joining social media can be integrated into the embodiments in a variety of manners.

Augmented reality means a technology that superimposes a computer-generated image on a user's view of the real world, thus providing a composite view. In an example of this invention, a real time view of the game can be seen and a “bet” which is a computer-generated data point is placed above the player that is bet on. Augmented reality can be integrated into the embodiments in a variety of manners.

Some embodiments of this disclosure, illustrating all its features, will now be discussed in detail. It can be understood that the embodiments are intended to be open ended in that an item or items used in the embodiments is not meant to be an exhaustive listing of such item or items, or meant to be limited to only the listed item or items.

It can be noted that as used herein and in the appended claims, the singular forms “a,” “an,” and “the” include plural references unless the context clearly dictates otherwise. Although any systems and methods similar or equivalent to those described herein can be used in the practice or testing of embodiments, only some exemplary systems and methods are now described.

This is a system for a personalized wagering on live events. This system includes a live event 102, for example a sporting event such as a football game, basketball game, baseball game, hockey game, tennis match, golf tournament, etc. The live event will include some number of actions or plays, upon which a user or bettor or customer can place a bet or wager, typically through an entity called a sportsbook. There are numerous types of wagers the bettor can make, including, but not limited to a straight bet, a money line bet, a bet with a point spread or line that bettor's team would need to cover, if the result of the game with the same as the point spread the user would not cover the spread, but instead the tie is called a push. If the user is betting on the favorite, they are giving points to the opposing side, which is the underdog or longshot. Betting on all favorites is referred to as chalk, this is typically applied to round robin, or other styles of tournaments. There are other types of wagers, including parlays, teasers and prop bets, that are added games, that often allow the user to customize their betting, by changing the odds and payouts they receive on a wager. Certain sportsbooks will allow the bettor to buy points, to move the point spread off of the opening line, this will increase the price of the bet, sometimes by increasing the juice, vig, or hold that the sportsbook takes. Another type of wager the bettor can make is an over/under, in which the user bets over or under a total for the live event, such as the score of American football or the run line in baseball, or a series of action in the live event. Sportsbooks have an amount of bets they can handle, a limit of wagers they can take on either side of a bet before they will move the line or odds off of the opening line. Additionally, there are circumstance, such as an injury to an important player such as a listed pitcher, in which a sportsbook, casino or racino will take an available wager off the board. As the line moves there becomes an opportunity for a bettor to bet on both sides at different point spreads in order to middle and win both bets. Sportsbooks will often offer bets on portions of games, such as first half bets and half time bets. Additionally, the sportsbook can offer futures bets on live events in the future. Sportsbooks need to offer payment processing services in order to cash out customers. This can be done at kiosks at the live event or at another location, at element 102.

The system may include a plurality of sensors 104 that may be used such as motion sensors, temperature sensors, humidity sensors, cameras such as an RGB-D camera which is a digital camera providing color (RGB) and depth information for every pixel in an image, microphones, radiofrequency receiver, a thermal imager, a radar device, a lidar device, an ultrasound device, a speaker, wearable devices etc. Also, the plurality of sensors may include tracking devices, such as RFID tags, GPS chips or other such devices embedded on uniforms, in equipment, in the field of play, in the boundaries of the field of play, or other markers on the field of play. Imaging devices may also be used as tracking devices such as player tracking that provides statistical information through real-time X, Y positioning of players and X, Y, Z positioning of the ball, at element 104. The system also includes a cloud 106 or communication network may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over Internet and relies on sharing of resources to achieve coherence and economies of scale, like a public utility, while third-party clouds enable organizations to focus on their core businesses instead of expending resources on computer infrastructure and maintenance. The cloud may be communicatively coupled to server 108 which may perform real time analysis on the type of play and the result of the play. The cloud may also be synchronized with game situational data, such as the time of the game, the score, location on the field, weather conditions, and the like which may affect the choice of play utilized. For example, in other exemplary embodiments, the cloud may not receive data gathered from sensors and may, instead, receive data from an alternative data feed, such as SportsRadar. This data may be provided substantially immediately following the completion of any play and the data from this feed may be compared with a variety of team data and league data based on a variety of elements, including down, possession, score, time, team, and so forth, as described in various exemplary embodiments herein, at element 106.

A live event API 108, or application program interface, for delivering data from the live event 102 to the server 110 and user device 118, at element 108. The system may include a server 110 which may perform real time analysis on the type of play and the result of a play or action. The server 110 (or cloud 106) may also be synchronized with game situational data, such as the time of the game, the score, location on the field, weather conditions, and the like which may affect the choice of play utilized. For example, in other exemplary embodiments, server 110 may not receive data gathered from sensors and may, instead, receive data from an alternative data feed, such as SportsRadar. This data may be provided substantially immediately following the completion of any play and the data from this feed may be compared with a variety of team data and league data based on a variety of elements, including down, possession, score, time, team, and so forth, as described in various exemplary embodiments herein. The server can offer a number of software as a service managed services such as, user interface service, risk management service, compliance, pricing and trading service, IT support of the technology platform, business applications, game configuration, state based integration, fantasy sports connection, integration to allow the joining of social media, as well as marketing support services that can provide engaging promotions to the user, at element 110. The eligible bet database 112 stores criteria for valid bets, such as a play, including when betting begins and closes. Play data can be any sensor data that indicates anything about the live game, such as, but no limited to audio of visual data that indicates “actions”, “sides”, “event” data, “total” data, “listed pitchers”, specific players, whistles, fouls, touchdowns, goals, yardage, player error, etc., at element 112. A historic play database 114 which stores all the historic plays of an event, at element 114. The odds calculation module 116 uses data from the historic play database 114 to calculate the probability of an event occurring corresponding with an eligible bet as defined by the eligible bet database 112, and determining the baseline odds, at element 116. A user device such as a computing device, laptop, smartphone, tablet, computer, smart speaker, or I/O devices. I/O devices may be present in the computing device. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wiimote for the WIT, Nintendo WII U GAMEPAD, or Apple IPHONE. Some devices allow gesture recognition inputs through combining some of the inputs and outputs. Some devices provide for facial recognition which may be utilized as an input for different purposes including authentication and other commands. Some devices provides for voice recognition and inputs, including, e.g., Microsoft KINECT, SIRI for IPHONE by Apple, Google Now or Google Voice Search.

Additional devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices or group of devices may be augmented reality devices. The I/O devices may be controlled by an I/O controller. The I/O controller may control one or more I/O devices, such as, e.g., a keyboard and a pointing device, e.g., a mouse or optical pen. Furthermore, an I/O device may also provide storage and/or an installation medium for the computing device. In still other embodiments, the computing device may provide USB connections (not shown) to receive handheld USB storage devices. In further embodiments, an I/O device may be a bridge between the system bus and an external communication bus, e.g. a USB bus, a SCSI bus, a FireWire bus, an Ethernet bus, a Gigabit Ethernet bus, a Fibre Channel bus, or a Thunderbolt bus. The user device can leverage the sensors in for purposes such as automatic content recognition, augmented reality or the synchronization of screens between the user device interface and other displays, at element 118. The interface(s) 120 may either accept inputs from users or provide outputs to the users, or may perform both the actions. In one case, a user can interact with the interface(s) 120 using one or more user-interactive objects and devices. The user-interactive objects and devices may comprise user input buttons, switches, knobs, levers, keys, trackballs, touchpads, cameras, microphones, motion sensors, heat sensors, inertial sensors, touch sensors, or a combination of the above. Further, the interface(s) 120 may either be implemented as a Command Line Interface (CLI), a Graphical User Interface (GUI), a voice interface, or a web-based user-interface, at element 120. A base module 122 receives data from the live event API 108, the user interaction database 128, eligible bet database 112, wager history database 124, and initiating an odds calculation module 116, and a user interaction module 126, to determine betting opportunities and adjusted odds for a specific user, at element 122. A wager history database 124 stores all the wagers made by an individual bettor including the odds and the amount wagered. In an embodiment, the wager history database 124 also storing bets that were presented to the user but for which a wager was not placed by the bettor, at element 124. A user interaction module 126 collects user interactions with a user device 118 and saves the collected data to the user interaction database 126, at element 126. A user interaction database 128 stores user interaction data collected by the user interaction module 126 including user inputs from buttons, touch screen display, keyboard, camera, accelerometer, or capacitive sensors which may indicate any of the user's knowledge, preferences, attentiveness and level of engagement with the user device 118, at element 128. The user device 118 may include a plurality of mobile device sensors 130 that may be used including any of an accelerometer, tilt sensor, gyroscope, camera, thermometer, hygrometer, photocell, microphone, GPS, bluetooth, Wi-Fi or touchscreen which provide data about the user or the environment proximal the user, at element 130.

Functioning of the eligible bet database will now be explained with reference to FIG. 2. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the eligible bet database 112. The eligible bet database 112 stores criteria for valid bets, such as they type of event, play, when betting begins and closes, and the criteria which determines whether or not the bet was successful. The eligible bet database 112 is created by a user who is authorized to create and define betting criteria. In an embodiment, this authorized user is an employee overseeing the operation of the wagering platform. In another embodiment, the authorized user is a user of the wagering platform who manually created a bet, defining the required criteria which is then saved in the eligible bet database 112. The eligible bet database 112 is used by the base module to collect eligible bets which are relevant to an event, in figure 200,

Functioning of the historic play database will now be explained with reference to FIG. 3. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the historic play database 114. The historic play database 114 stores data describing each play including the event, time and date, they type of play, who participated in the play such as the team or players on offense or defense, and the result of the play. This data is collected from the live event API and is used by the odds calculation module to calculate the probability and odds for an eligible bet, in figure 300.

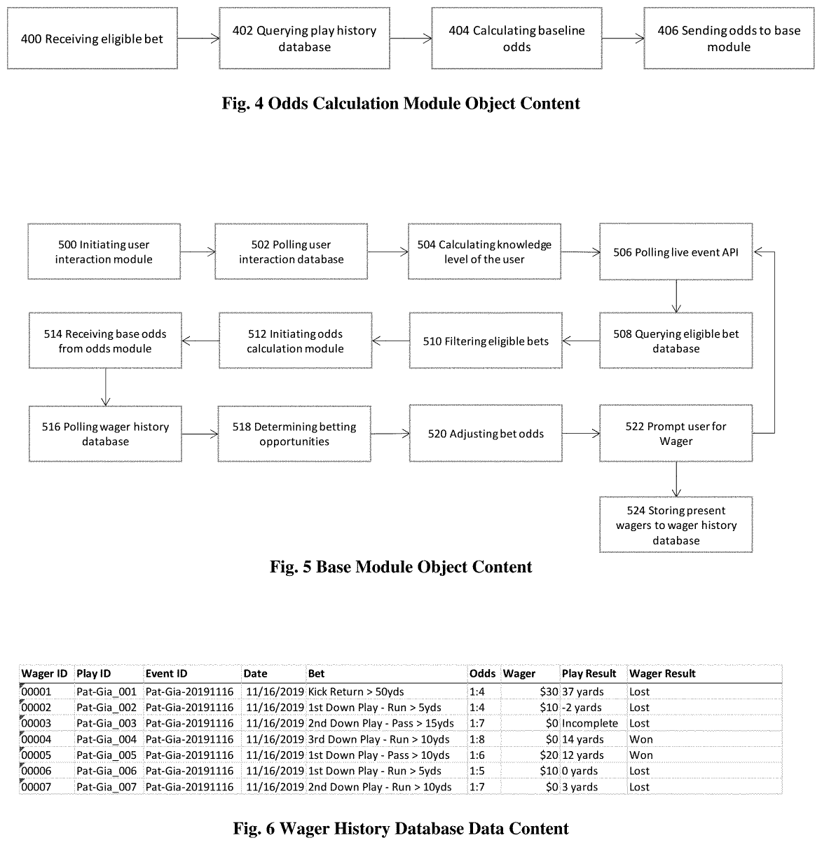

Functioning of the odds calculation module will now be explained with reference to FIG. 4. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the odds calculation module 116. The process begins with receiving an eligible bet from the base module for which to calculate baseline odds. In an embodiment, the eligible bet is whether or not an offensive player in a football game will gain enough yards on the next play to achieve a first down; at step 400. Querying the play history database 116 for plays and outcomes related to the eligible bet. In an embodiment, the eligible bet is whether or not an offensive player in a football game will advance the ball enough yards to achieve a first down. The database will be queried for the total number of plays attempted further than 10 yards from the goal line, and the number of those attempts which succeeded in achieving a first down or a touchdown. The data may also include the number of yards required to achieve a first down in each of the play attempts or alternatively the data retrieved may include only the play attempts with a number of yards to first down equaling the total number of yards required for a first down for the current eligible bet. The data may further be refined to include only data pertaining to one or both teams participating in the game and may further specify the players involved, such as the quarterback and players on the defensive line and data relating to their past performances, at step 402. Determining the historical frequency of plays and outcomes and calculating the odds based on the probability of the play and outcome occurring. In an embodiment, the total number of successful attempts of achieving a first down in a football game is divided by the total number of attempts made to determine a percentile probability of a successful play. Further converting the percentile probability to a fractional probability, rounding to the nearest whole number to convert the probability to the baseline odds (i.e. 0.284=2:7, 0.197=1:5), at step 404. Sending the baseline odds to the base module, at step 406.

Functioning of the base module will now be explained with reference to FIG. 5. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the base module 122 The process begins when the base module 122 initiates the user interaction module 126 to collect user interaction data from the user via the user device 118. The user interaction module 126 polling at least one mobile device sensor 130, presenting questions to the user to get user extracted data and determine the user's experience level, and monitoring the user's interactions with the user device 118 to determine the user's level of attentiveness and level of engagement. Storing the user interaction data in the user interaction database 128, at step 500. The base module 122 polls the user interaction database 128 for data collected by the user interaction module 126 to obtain user extracted data. In an embodiment, collecting user interaction data to get the user extracted data includes a user's response to questions or prompts. An example of prompts is the task of identifying several players participating the football game, at step 502. User extracted data could include user indications of preferences for specific teams and/or players, this may allow the system to show the user more wagers, or targeted wagers, related to those teams and/or players as the user is considered more knowledgeable about their preferred teams and/or players. User extracted data could also include data from the mobile device sensors 130. This may include geolocation data, which could be used as an indication of increased knowledge of the local team. This may also include engagement tracking metrics, such as eye gaze tracking, that indicate the user's level of engagement with the wagering app, or other related apps such as an analytics service. Long in app times with good engagement metrics may be used to indicate increased knowledge of the user. The base module 122 calculates a knowledge level of the user by comparing the user's responses to questions or prompts stored in the user interaction database 128 to the expected responses and calculating the percentage of correct responses. The user extracted data is used for determining the user is knowledgeable about the live event if the user provides correct answers for at least half of the questions or prompts. In an embodiment, the user is prompted to identify several players who will be participating in the football game that the user intends to place bets on, and upon correctly identifying at least half of the players, is determined to be knowledgeable about the live event, allowing the user to be presented with betting opportunities, such as player specific bets. Alternatively, upon failing to correctly identify at least half of the players as prompted, restricting the user to only team specific betting opportunities and preventing the presentation of player specific bets as the user is determined to lack the knowledge to place bets on player specific bets, at step 504. The base module 122 polls live event API 108 for data from a live event 102. In an embodiment, the live event 102 is a football game, and the data collected from the live event API 108 may include plays, the results of the plays, the players involved in each play, the score and plays resulting in score changes as well as penalties, at step 506. The base module 122 queries the eligible bet database 112 for betting opportunities which may be presented to a user based on data available from the live event API 108. In an embodiment, the live event is a football game and a betting opportunity comprising any of the action and outcome of a play including first down, scoring event, whether the ball was run or passed for completion over a minimum or specific number of yards and optionally the player who executed the play. For example, an eligible bet may be whether or not a team will get a first down on the next play, at step 508. The base module 122 filters eligible bets from the eligible bet database 112 which are relevant to the live event 102. In an embodiment, the user is determined, based on user extracted knowledge, to have a low level of knowledge about the live event, a football game, and therefore any otherwise eligible bets pertaining to specific players are not selected, and only team specific bets are selected, at step 510. The base module 122 sends the selected eligible bets to the odds calculation module 116 to determine the base odds for each selected eligible bet. The odds calculation module 116 receiving an eligible bet, polling the historic play database 114 for plays and outcomes related to the bet, determining the frequency of past plays and outcomes, calculating the probability of the play and outcome occurring and converting the probability into a baseline odd, at step 512. The base module 122 receives the calculated base odds for each eligible bet from the odds calculation module 116. The odds being in a fractional format such as 1:5 or 1:7 at step 514. The base module 122 polls the wager history database 124 for past wagers made by the user relevant to the live event 102. In an embodiment, the live event 102 is a football game, and past wagers may include bets placed on whether a team would make a first down on a given play or whether the offensive team would score a touchdown on a given play. Further polling the wager history database 124 for the odds associated with past wagers and determining a pattern of bets made by the user, such as a preference for a particular type of wager, such as betting on scoring plays, or betting on particular odds, such as bet opportunities with odds greater than, for one example, 1:10, at step 516. The base module 122 determines which betting opportunities from the selected eligible bets to present to the user. The determination may use any data from the user interaction database 128 (such as GPS location or engagement level) or the wager history database 124 (such as patterns of preferred bets or preferred odds) to determine the betting opportunities most likely to be bet on by the user. In an embodiment, three bets are identified to be presented to the user for the next play on 3rd down: run at least 5 yards for first down with 1:7 odds, 37 yard field goal attempt with 1:5 odds, and at least 10 yard pass for first down with for example, 1:6 odds, at step 518. The base module 122 adjusts the bet odds using any of, engagement level, GPS location of the user or past wagers by increasing the odds in favor of the user to incentivize the user to make a bet or to reduce the odds for the user for bets the user is likely to make regardless of the odds as to reduce the potential payout. In an embodiment, the user has placed bets on whether a player will score on a play with fewer than, for example, 0 yards to goal, however only does so, for example 25% of the time when the odds are equal to the baseline odds of, for example, 1:5. To incentivize the user to take the bet, the odds are increased in favor of the user to 1:7 to increase the likelihood the user will make a bet, at step 520. The base module 122 presents an adjusted bet odd to the user of a user device 118 and prompting the user to select at least one wager. In an embodiment, the user selecting a bet with adjusted odds of for example, 1:5 that the quarterback of the team on offense will be sacked in the next play and wageringa, for example, $10, at step 522. The base module 122 receives a wager from the user via the user device 118 and storing the wager to the wager history database 124. It should be noted that the base module can be made available for access, reconfiguration, modification, or control for “customers” or used for “Managed service user interface service”, “Managed service risk management services”, “Managed service compliance service”, “Managed service pricing and trading service”, “Managed service and technology platform”, “Managed service and marketing support services”, “Payment processing services”, “Engaging promotions”, “Customized betting”, “Business Applications”, “State based integration”, “Game Configurator”, “Fantasy sports connector”, “Software as a service”, “Synchronization of screens”, “Automatic content recognition (ACR)”, “Joining social media”, and “Augmented reality”, at step 524.

Functioning of the wager history database will now be explained with reference to FIG. 6. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the wager history database 124. The wager history database 124 stores all the wagers made by an individual user including the odds, the amount wagered and the results of the wager. In an embodiment, the wager history database also stores bets that were presented to the user but for which a wager was not placed by the user. The wager history database 124 is updated by the base module when a user submits a wager and is used by the base module to determine wagering behaviors of the user in FIG. 600.

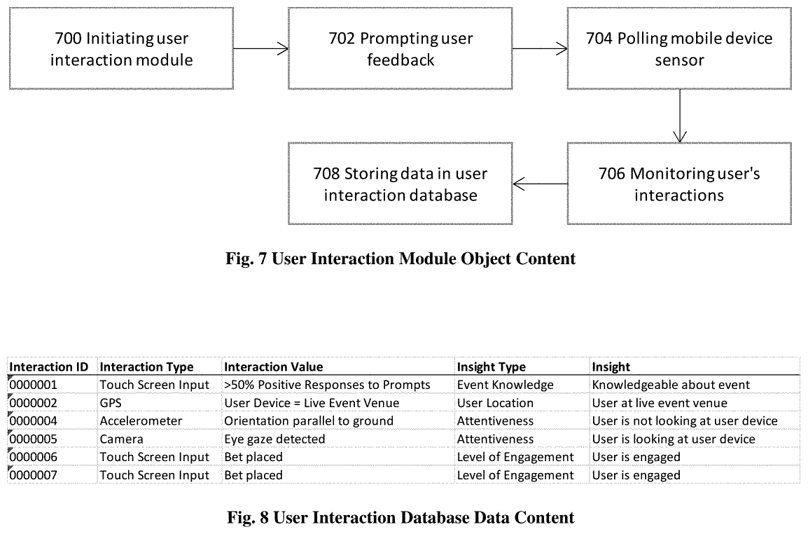

Functioning of the user interaction module will now be explained with reference to FIG. 7. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the user interaction module 126. The process begins with the base module 122 initiating the user interaction module 126, at step 700. The user interaction module 126 presents a game, quiz or series of questions to the user which can be used to obtain user extracted data to determine the user's level of experience and knowledge of the live event. In an embodiment, the user intends to bet on a football game and may be asked to identify a half dozen players participating in the game. If the user positively matches a majority of the players, then the user is determined to have a high knowledge of the event being bet on and therefore may be presented with additional eligible bets such as those specifying the performance of individual players. If the user does not positively match a majority of the players, the user is determined to have a lower knowledge of the event being bet on and would only be presented with team level betting opportunities, at step 702. The user interaction module 126 polls at least one mobile device sensor 130 such as a GPS, camera, accelerometer, tilt sensor or touch screen input. In an embodiment, polling the GPS sensor of the user device 118 and determining that the location of the user device is in or near the live event venue. In another embodiment, polling the accelerometer, tilt sensor, or camera to determine whether the user is looking at the user device 118, or is holding the user device 118 in an orientation indicating the user is or may be looking at the device, at step 704. The user interaction module 126 monitors the user's interactions with the user device 118. User interactions can include any of providing user inputs via buttons, keyboard, stylus, or a touch screen interface to a prompt, such as question or prompt. User interactions can further include any sensor data such as from a camera, accelerometer or tilt sensor, which can indicate the level of interaction or attentiveness of the user. In an embodiment, the user may be holding the user device 118 with the screen parallel to the ground, indicating that the user is not looking at or interacting with the device. Alternatively, the user may be scrolling through a list of bets indicating that the user is engaged with the device, at step 706. The user interaction module 126 stores the user interaction data in the user interaction database 128, at step 708.

Functioning of the user interaction database will now be explained with reference to FIG. 8. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the user interaction database 128. The user interaction database 128 stores user interaction data collected by the user interaction module including user inputs from buttons, touch screen display, keyboard, camera, accelerometer, or capacitive sensors which may indicate any of the user's knowledge, preferences, attentiveness and level of engagement with the user device. The data is used by the base module to determine the level of experience of the user to allow filtering of eligible bets to only present those to the user for which the user has demonstrated knowledge. The data in the User Interaction Database 128 is further used by the base module to identify bets to present to the user, in FIG. 800.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method of offering a bet on a play at a live event, comprising:
selecting at least one bet to present to a bettor in a betting game,
calculating baseline odds for the bet,
adjusting the baseline odds for the bet based on user extracted data, and
presenting the bet with odds adjusted based on the user data to the user.

2. The method of claim 1, further comprising polling the user for the user extracted data on a mobile device to determine a knowledge level of the user.

3. The method of claim 2, wherein the polling comprises a plurality of questions related to an experience level of the user and a review of past interactions of the user in the betting game.

4. The method of claim 3, wherein the polling further comprises asking one or more questions of the user and/or prompting the user for specific information.

5. The method of claim 4, wherein the questions and/or prompting for specific information are related to the live event.

6. The method of claim 1, further comprising limiting available bets presented to the user based on the specific user data.

7. The method of claim 1, further comprising providing targeted bets to the user based on the user extracted data.

8. The method of claim 1, further comprising collecting the user extracted data from one or more mobile device sensors.

9. The method of claim 8, further comprising determining an engagement level of the user to the betting game based on the user extracted data.

10. A method of offering bets on a play at a live event, comprising:
compiling a plurality of bets available to be offered in a betting game;
calculating baseline odds for each of the plurality of bets;
determining a knowledge level of a user of the betting game based on user extracted data; and
adjusting at least one of the availability of bets among the plurality of bets and the odds of bets among the plurality of bets based on the knowledge level of the user.

11. The method of claim 10, further comprising determining a knowledge level of the user by polling the user.

12. The method of claim 11, wherein information polled is related to the live event.

13. The method of claim 11, wherein information polled is related to historical bets placed by the user.

14. The method of claim 11, further comprising determining an engagement level of the user in the betting game.

15. A computer implemented method for providing bets on a play at a live event, comprising executing on a processor the steps of:
displaying a betting game interface;
displaying one or more live events, the one or more live events capable of having wagers placed thereon;
displaying one or more questions or prompts for information; and
displaying one or more bets available to be made as a result to data collected and analyzed in response to the one or more questions or prompts for information.

16. The computer implemented method of claim 15, further comprising displaying questions or prompts related to the live event.

17. The computer implemented method of claim 15, further comprising displaying first odds before the display of the one or more questions or prompts for information and displaying second odds after the display of the one or more questions or prompts for information.

18. The computer implemented method of claim 15, further comprising displaying data received in response to the one or more questions or prompts for information.

19. The computer implemented method of claim 15, further comprising displaying data collected by one or more mobile device sensors.
